(19) United States
(12) Patent Application Publication
(10) Pub. No.: US 2017/0343085 A1
(43) Pub. Date: Nov. 30, 2017

(54) RECORDING APPARATUS AND MOTION UNIT DRIVE METHOD

(71) Applicant: SEIKO EPSON CORPORATION, Tokyo (JP)

(72) Inventors: Takayuki TANAKA, Matsumoto (JP); Hirotomo TANAKA, Shiojiri (JP); Yasuhiko YOSHIHISA, Matsumoto (JP)

(21) Appl. No.: 15/602,439

(22) Filed: May 23, 2017

(30) Foreign Application Priority Data
May 30, 2016 (JP) 2016-107275

(51) Int. Cl. F16H 19/06; B41J 23/00

(52) U.S. Cl. CPC F16H 19/0672; B41J 23/00; F16H 2019/0686

(57) ABSTRACT

Provided are a recording apparatus and a motion unit drive method that determines a stop rotation torque of a CR motor indicating stop of a carriage by a stopper and, within a predetermined period after the determination of the stop rotational torque, supplies to the CR motor the drive signal that causes a rotational torque of the drive motor to be a low rotational torque having a smaller torque value than the stop rotational torque.

### BACKGROUND

### 1. Technical Field

The present invention relates to a recording apparatus and a motion unit drive method for moving a motion unit by using a drive motor.

### 2. Related Art

There have been printing apparatuses having a recording apparatus that causes a carriage, which is an example of a motion unit, to move bi-directionally (reciprocate) by using a drive motor and adapted to print images or the like by ejecting ink, which is an example of a liquid, onto a sheet from an ejecting head or the like that is provided on the motion carriage and ejects a liquid. In such a printing apparatus, a carriage is moved to collide with a stopper, and the collision position where the carriage collides with the stopper is defined as a reference position (a home position) of the carriage during printing of an image on a sheet.

Thus, there is a scheme of determining a collision position of a carriage by using rotational torque of a drive motor that moves the carriage. For example, there is a determination scheme in which a collision position of a carriage is determined on the basis of the rotational torque of a drive motor increasing when the carriage collides (see, for example, JP-A-2006-248104). Further, in another scheme, for accurate determination of the collision position of a carriage, increased rotational torque of a drive motor is reduced by a predetermined level and, when the carriage is not moved by the rotational torque of the reduced torque, the position of the carriage is determined as the collision position (see, for example, JP-A-2010-253748).

The inventors of the present application have found a problem that occurs when a motion unit attached to an endless belt stretched between a driving pully, which is rotated by a drive motor, and a driven pully, which is movable in the actuation direction of the actuation member by being actuated by an actuation member, is stopped due to collision with a stopper.

That is, when a motion unit moving from the driving pulley side to the driven pulley side and consequently toward the stopper in a rotating direction of the belt is stopped by collision with the stopper, the rotational torque of the driving motor that has been rotated continues to force the driving pulley to rotate. Thus, a portion of the stretched belt located on the downstream side of the driven pulley in the rotating direction is pulled toward the downstream side in the rotating direction by rotation of the driving pulley, and this causes the driven pulley to move in a direction opposite to the actuation direction of the actuation member. Then, when the rotation of the driving motor stops after a collision position of the motion unit is determined, the actuation force of the actuation member causes the driven pulley, which has been moving in the direction opposite to the actuation direction of the actuation member, to quickly return to the previous position where the driven pulley was before moving. At this time, an abnormal noise (sudden noise) due to the quick returning of the driven pulley occurs, which is considered a problem when a motion unit of a recording apparatus stops.

However, the related arts involve a technique of determining a collision position of a motion unit, while no consideration is given to the problem of an abnormal noise that may occur in the motion unit drive apparatus when the motion unit is stopped as a result of collision. Note that such a problem is generally common to any recording apparatus having a motion unit attached to a belt stretched between a first pulley, which is rotated by a drive motor, and a second pulley, which is movable by being actuated by an actuation member, and a stopper with which the motion unit collides.

### SUMMARY

An advantage of some aspects of the invention is to provide a recording apparatus and a motion unit drive method that can suppress an abnormal noise that may occur when a motion unit stops.

A recording apparatus includes: a drive motor that rotates in response to a supplied drive signal; a motor drive unit that supplies a drive signal to the drive motor; a belt that is stretched between a first pulley that is rotated by the drive motor and a second pulley that is movable in an actuation direction by being actuated by an actuation member and that rotates in response to rotation of the first pulley; a motion unit that is attached to the stretched belt and moves in response to rotation of the belt; a stopper that stops the motion unit from traveling from the first pulley side to the second pulley side in a rotating direction of the belt as a result of collision of the motion unit with the stopper; and a rotational torque determination unit that determines a stop rotational torque of the drive motor after the motion unit collides with the stopper. Within a predetermined period from determination of the stop rotational torque by the rotational torque determination unit, the motor drive unit supplies to the drive motor the drive signal that causes the rotational torque of the drive motor to be less than the stop rotational torque.

According to the configuration described above, at the time of the motion unit stopping, the drive signal supplied to the drive motor is not a signal which causes the rotational torque to be zero, and therefore, the belt is tensioned in the rotating direction, which suppresses the second pulley that is moved in the direction opposite to the actuation direction of the actuation member from quickly returning to the previous position that corresponds to a position before the motion. This can suppress occurrence of a noise (a sudden noise) when the motion unit stops.

In the recording apparatus described above, it is preferable that the low rotational torque be smaller than a rotational torque of the drive motor generated when the motion unit moves in response to rotation of the belt.

According to the configuration described above, the second pulley that moves when the motion unit is stopped can be stably returned to the previous position that corresponds to a position before the motion by using the actuation force of the actuation member.

In the recording apparatus described above, it is preferable that the predetermined period be longer than a period that elapses before the second pulley that is moved in a direction opposite to the actuation direction by the actuation member moves to a previous position that corresponds to a position before moving in the direction opposite to the actuation direction after the motion unit stopped.

According to the configuration described above, quick motion of returning to the previous position of the second pulley that moves when the motion unit is stopped can be suppressed at a high probability.

In the recording apparatus described above, it is preferable that the motor drive unit stop supplying the drive signal to the drive motor after the predetermined period.

According to the configuration described above, since no drive signal is supplied to the drive motor after the second pulley that is moved when the motion unit is stopped returns to the previous position, generation of heat by the drive motor can be suppressed.

In the recording apparatus described above, it is preferable to further include a speed determination unit that determines a traveling speed of the motion unit moving to the stopper, and the motor drive unit may supply, to the drive motor as the drive signal causing the low rotational torque, the drive signal corresponding to a rotational torque corresponding to a traveling speed of the motion unit determined by the speed determination unit when the motion unit collides with the stopper.

According to the configuration described above, quick motion of the second pulley back to the previous position can be properly suppressed by using the low rotation torque in accordance with the displacement of the second pulley.

In the recording apparatus described above, it is preferable that the low rotational torque have a plurality of different torque values and that the motor drive unit sequentially supply to the drive motor the drive signals in descending order of rotational torque among the plurality of torque values within the predetermined period.

According to the configuration described above, the second pulley that moves when the motion unit is stopped can be returned to the previous position that corresponds to a position before the motion at a constant speed, a stepwise decreasing speed, or the like.

A motion unit drive method is a method of moving a motion unit by supplying a drive signal from a motor drive unit to rotate a drive motor, the motion unit being attached to a belt that is stretched between a first pulley that is rotated by the drive motor and a second pulley that is movable in an actuation direction by being actuated by an actuation member and that is rotatable in response to rotation of the first pulley. The method includes: a collision step of moving the motion unit from the first pulley side to the second pulley side in a rotating direction of the belt and causing the motion unit to collide with a stopper; a rotation torque determination step of determining a stop rotational torque of the drive motor after causing the motion unit to collide with the stopper; and a drive signal supplying step of, within a predetermined period from determination of the stop rotational torque in the rotational torque determination step, supplying to the drive motor the drive signal that causes a rotational torque of the drive motor to be a low rotational torque having a smaller torque value than the stop rotational torque.

According to the configuration described above, since the belt is tensioned in the rotating direction, the second pulley that moves in the direction opposite to the actuation direction of the actuation member is suppressed from quickly returning to the previous position that corresponds to a position before the motion, which can suppress the occurrence of a noise (a sudden noise) when the motion unit stops.

### BRIEF DESCRIPTION OF THE DRAWINGS

The invention will be described with reference to the accompanying drawings, wherein like numbers reference like elements.

FIG. 1 is a perspective view schematically illustrating the structure of a printer that is an example of a printing apparatus having a recording apparatus.

FIG. 2 is a block diagram illustrating a configuration of the recording apparatus of the printer.

FIG. 3 is an illustrative diagram showing a drive signal supplied to a drive motor.

FIG. 4 is a graph illustrating a relationship between a rotational speed and rotational torque of the drive motor in accordance with the drive signal.

FIG. 5 is a flowchart illustrating a drive process of a motion unit performed by the recording apparatus.

FIG. 6 is an illustrative diagram showing a state in which the motion unit collides with a stopper.

FIG. 7 is a timing chart illustrating drive signals supplied in the drive process of the motion unit and elongation of an actuation member.

FIG. 8 is a schematic diagram illustrating an example in which the stopper of the motion unit is a paper feed selection unit.

### DESCRIPTION OF EXEMPLARY EMBODIMENT

An example of a recording apparatus will be described below with reference to the drawings.

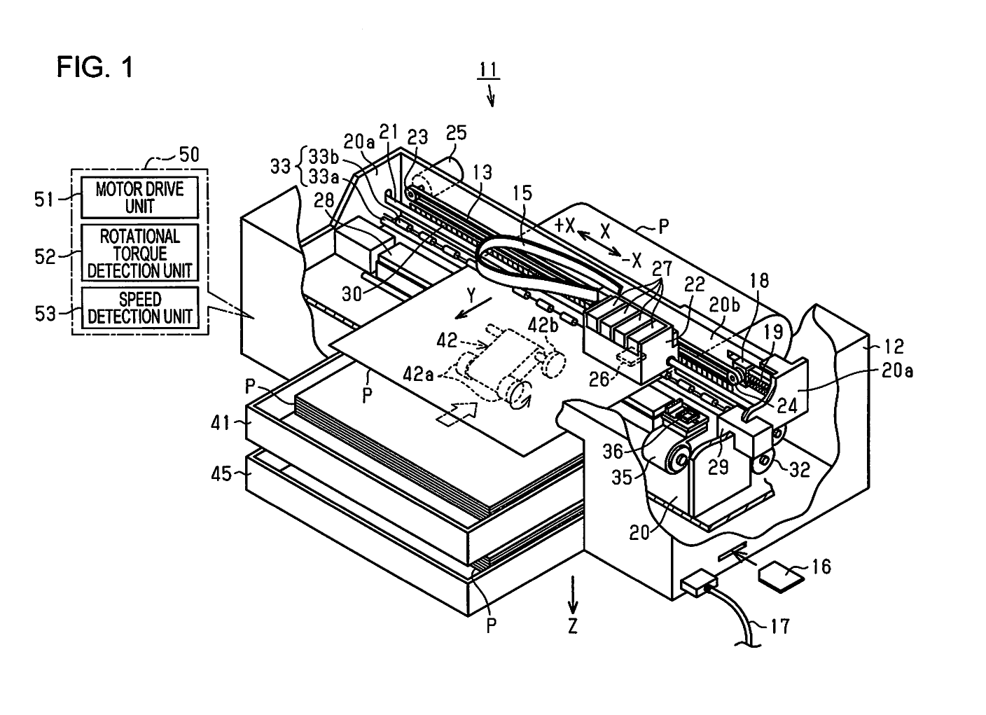

As illustrated in FIG. 1, a printer 11, which is an example of a printing apparatus having the recording apparatus of the present embodiment, is an ink jet printer that prints an image including text, a figure, or the like onto a sheet P, which is an example of a member on which printing is performed, by ejecting ink, which is an example of a liquid, from an ejecting head 26 provided on a carriage 22, which is an example of a motion unit. In the present embodiment, when printing is performed on the sheet P, the sheet P is transported in one direction while facing the ejecting head 26. The direction in which the sheet P is transported is defined as a transport direction Y, and a direction in the width direction of the sheet P crossing (preferably, orthogonal to) the transport direction Y is defined as a scan direction X in which a carriage 22 (the ejecting head 26) is reciprocated. That is, the scan direction X and the transport direction Y of the present embodiment are directions that cross (preferably, are orthogonal to) each other and cross (preferably, are orthogonal to) a downward gravity direction Z.

The printer 11 has a main unit frame 20 inside an apparatus main unit 12 having substantially a cuboidal shape with the longitudinal direction thereof being arranged in the scan direction X of the sheet P, and a guide shaft 21 having a certain length is placed between side walls 20a located on both sides in the longitudinal direction of the main unit frame 20. The carriage 22 is provided on the guide shaft 21 so as to be able to reciprocate in the longitudinal direction of the guide shaft 21. A first pulley 23, which is an example of a driving pulley, and a second pulley 24, which is an example of a driven pulley, are attached to a back plate 20b extending in the longitudinal direction of the main unit frame 20.

That is, a drive shaft (an output shaft) of a CR motor 25, which is an example of a drive motor rotated by a drive signal, is connected to the first pulley 23, and the first pulley 23 is rotated by the CR motor 25. The second pulley 24 is attached in a rotatable manner to the slide plate 18 that is slidable in the longitudinal direction of the main unit frame 20 on the back plate 20b of the main unit frame 20.

The main unit frame 20 has a tension spring 19 therein, which is an example of an actuation member, one end of which is fixed to the slide plate 18 and the other end of which is fixed to one of the side walls 20a which is on the side furthest from the first pulley 23 within the main unit frame 20. Further, in response to the slide plate 18 being pulled by the tension spring 19, the second pulley 24 attached to the slide plate 18 is able to move in the actuation direction (the scan direction X in this example) of the tension spring 19 by being actuated in a direction away from the first pulley 23.

An endless belt 13 is stretched between the first pulley 23 rotated by the CR motor 25 and the second pulley 24 actuated by the tension spring 19 to be movable in the actuation direction. While being stretched, that is, tensioned with the second pulley 24 being actuated by the tension spring 19, the belt 13 is able to be rotated in response to rotation of the first pulley 23. Further, the carriage 22 is fixed to a part of the rotatable stretched belt 13.

Therefore, in response to the CR motor 25 being driven for a forward rotation and a reverse rotation, the belt 13 rotates in both forward and reverse directions, and this causes the carriage 22 to reciprocate along the guide shaft 21 in the scan direction X, which is the width direction orthogonal to the transport direction Y of the transported sheet P. Note that, in the present embodiment, with respect to the scan directions X, a direction of movement in which the carriage 22 moves from the second pulley 24 side to the first pulley 23 side is referred to as a forward scan direction +X, and the opposite direction is referred to as a reverse scan direction −X.

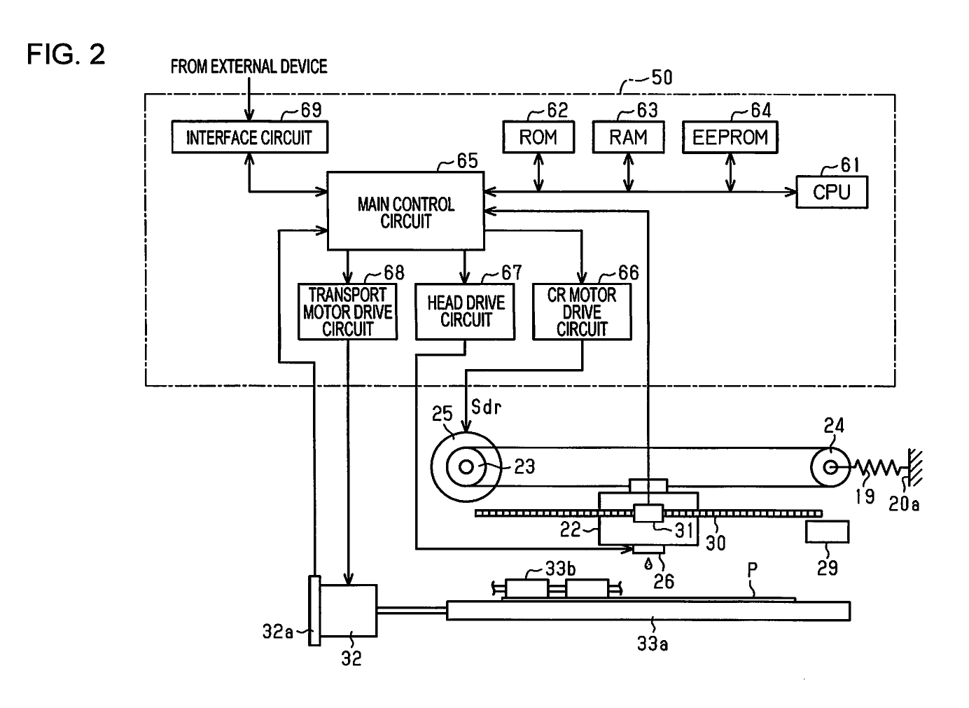

Further, a linear encoder for determining the position and the speed in the scan direction X of the reciprocating carriage 22 is provided inside the main unit frame 20. That is, the linear encoder is formed of a linear code plate 30 arranged parallel to the scan direction X and provided on the back plate 20b of the main unit frame 20 and a photo-sensor 31 (see FIG. 2) provided on the carriage 22, and the linear encoder outputs from the photo-sensor 31 a predetermined electrical signal corresponding to a motion state of the carriage 22.

An ejecting head 26 that ejects ink is provided on a portion beneath the carriage 22. Four ink cartridges 27, each of which contains one of multiple colors, for example, four colors, of ink (for example, black, cyan, magenta, and yellow), are loaded so that multiple colors may be used. Further, the ink contained in each of the loaded ink cartridges 27 is supplied to the ejecting head 26 along a flow path (not shown). The supplied ink is ejected as ink droplets (liquid droplets) from the ejecting head 26 (in particular, nozzles (not shown) provided on the ejecting head 26) on the basis of an electrical signal transmitted to the ejecting head 26 via a flexible substrate 15 from a control board (not shown) of the control unit 50 that controls various operations of the printer 11.

One end position on the traveling path of the reciprocating carriage 22 (an end position in the reverse scan direction −X side in this example) is a position where the carriage 22 remains in a stand-by state when not printing and thus is a reference position (a home position) of the carriage 22 when used for printing an image on the sheet P. That is, a stopper 29 is provided on a side wall in the reverse scan direction −X side of the main unit frame 20, and a collision position where at least a portion of the carriage 22 moving in the reverse scan direction −X collides with the stopper 29 is defined as the reference position of the carriage 22.

Note that, in the present embodiment, a maintenance device 35, which is an example of a maintenance unit that performs maintenance of the ejecting head 26 such as nozzle cleaning, is provided directly under the carriage 22 that has moved to the reference position. The maintenance device 35 has a cap 36 that is able to come into contact with the ejecting head 26 so as to surround the nozzles, for example, and performs nozzle cleaning by reducing the pressure of a space defined by the cap 36 to cause unnecessary ink or bubbles to be discharged.

On the gravity direction Z side of, that is, below the traveling path of the carriage 22 reciprocating along the guide shaft 21, a support stage 28 defining a clearance (a gap) between the ejecting head 26 and the sheet P is provided extending parallel to the guide shaft 21. While being supported by the support stage 28, the sheet P passes between the ejecting head 26 and the support stage 28 and is transported by pairs of rollers in the transport direction Y crossing the scan direction X.

The pairs of rollers include a pair of transport rollers 33 and a pair of discharge rollers (not shown) that are arranged on the upstream side and the downstream side interposing the support stage 28 in the transport direction Y of the sheet P. The pair of transport rollers 33 are formed of a transport driving roller 33a driven and rotated by power of the transport motor 32 and a transport driven roller 33b that is in contact with the transport driving roller 33a and rotated accordingly. Further, drive and rotation of the transport motor 32 disposed on the main unit frame 20 causes the sheet P to be transported in the transport direction Y nipped between the pair of transport rollers 33 and between the pair of discharge rollers.

In the printer 11 of the present embodiment, a first paper feed tray 41 and a second paper feed tray 45 that feed the sheet P transported between the ejecting head 26 and the support stage 28 are loaded into the apparatus main unit 12. The first paper feed tray 41 and the second paper feed tray 45 can accommodate the stacked sheets P, and the stacked sheets P are fed out one by one by a paper feed mechanism in a direction opposite to the transport direction Y.

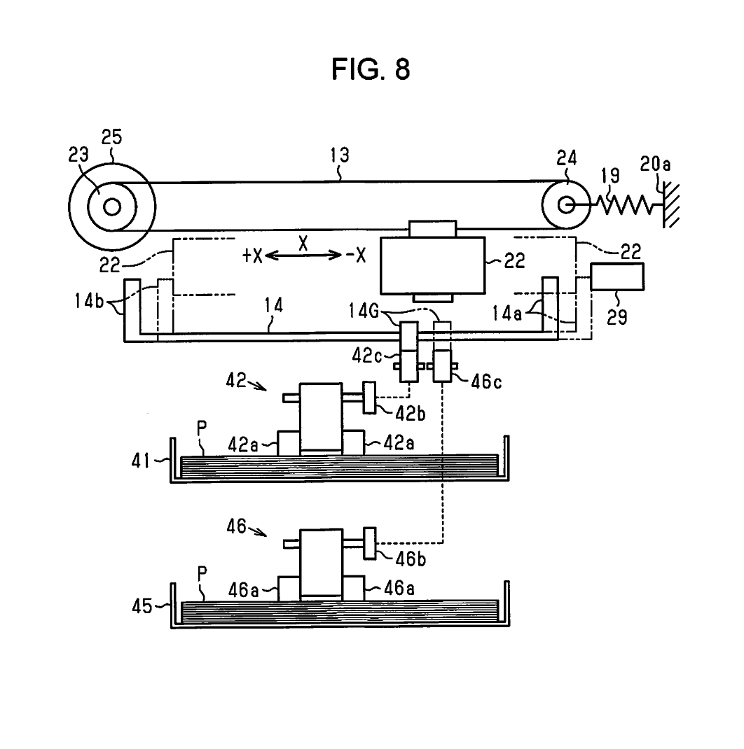

That is, a paper feed mechanism 42 is provided for the first paper feed tray 41, and a paper feed roller 42a is rotated in response to rotation of a transmission gear 42b of the paper feed mechanism 42, and thereby the stacked sheets P are fed out one by one in a direction opposite to the transport direction Y as depicted by a white arrow with a two-dot chain line in FIG. 1. In a similar manner, although not depicted in FIG. 1, a paper feed mechanism 46 (see FIG. 8) similar to the paper feed mechanism 42 is provided for the second paper feed tray 45, and the stacked sheets P are fed out one by one in a direction opposite to the transport direction Y. The sheet P fed out from the first paper feed tray 41 or the second paper feed tray 42 is then directed to the transport direction Y side to be reversed via a turning transport path (not shown) provided on the feeding side and is transported toward the gap between the ejecting head 26 and the support stage 28.

Print commands, print data, and the like are input to the printer 11 via a storage medium 16 or a signal cable 17. In the printer 11, based on the input print data, an image is printed on the sheet P by repetition of an ejecting operation in which ink is ejected from the ejecting head 26 at a predetermined timing while the carriage 22 is being reciprocated in the scan direction X and a transport operation in which the sheet P is transported in the transport direction Y by a predetermined transport amount. Thus, in the printer 11, the control unit 50 controls a motion operation of the carriage 22 in the scan direction X, an ejecting operation of ink from the ejecting head 26, and a transport operation of the sheet P.

As illustrated in FIG. 2, in the present embodiment, the control unit 50 has a computer consisting of a central processing unit (CPU) 61 provided on a control board and storage components such as a ROM 62, a RAM 63, an EEPROM 64, and various electrical circuits such as a main control circuit 65, a CR motor drive circuit 66, a head drive circuit 67, and a transport motor drive circuit 68.

The CR motor drive circuit 66 supplies a drive signal Sdr to drive the CR motor 25. An electrical signal output from the photo-sensor 31 of the linear encoder for determining the position and the speed in the scan direction X of the carriage 22 moving in response to driving of the CR motor 25 is input to the main control unit 65.

The head drive circuit 67 drives an ejecting mechanism (not shown) provided on the ejecting head 26 mounted on the carriage 22 to eject ink droplets onto the sheet P from a plurality of nozzles. Note that paper, cloth, film, or the like other than the sheet P may be employed as a printing medium.

The transport motor drive circuit 68 drives the transport motor 32 to rotate the transport drive roller 33a and thereby moves the sheet P in the transport direction Y orthogonal to the primary scan direction. A rotary encoder 32a is provided for the transport motor 32, and an electrical signal output from the rotary encoder 32a is input to the main control circuit 65.

The main control circuit 65 has a function of supplying control signals to the CR motor drive circuit 66, the head drive circuit 67, and the transport motor drive circuit 68, respectively. Further, the main control circuit 65 has a function of decoding various print commands that are input from external devices via the storage medium 16 or the signal cable 17 or received from the outside via an interface circuit 69 and a function of performing control regarding adjustment of print data or the like.

As illustrated in FIG. 1, in the control unit 50 of the printer 11 having such a configuration, operation of the computer based on a predetermined program stored in the storage component enables the control unit 50 to function as a motor drive unit 51, a rotational torque determination unit 52, and a speed determination unit 53.

The motor drive unit 51 includes the main control circuit 65 and the CR motor drive circuit 66 and supplies the drive signal Sdr, which drives and rotates the CR motor 25, from the CR motor drive circuit 66 to the CR motor 25. Note that, in the present embodiment, control of input values (for example, the traveling speed of the carriage 22 or the like) is performed by using so-called PID control in which consists of three factors of a deviation between an output value and a target value, an integral thereof, and a differential thereof, and the motor drive unit 51 supplies the drive signal Sdr based on the PID control to the CR motor 25.

The rotational torque determination unit 52 includes the main control circuit 65 and determines the rotational torque of the CR motor 25. Further, the speed determination unit 53 includes the main control unit 65 and determines the traveling speed of the carriage 22 by using an electrical signal output from the photo-sensor 31.

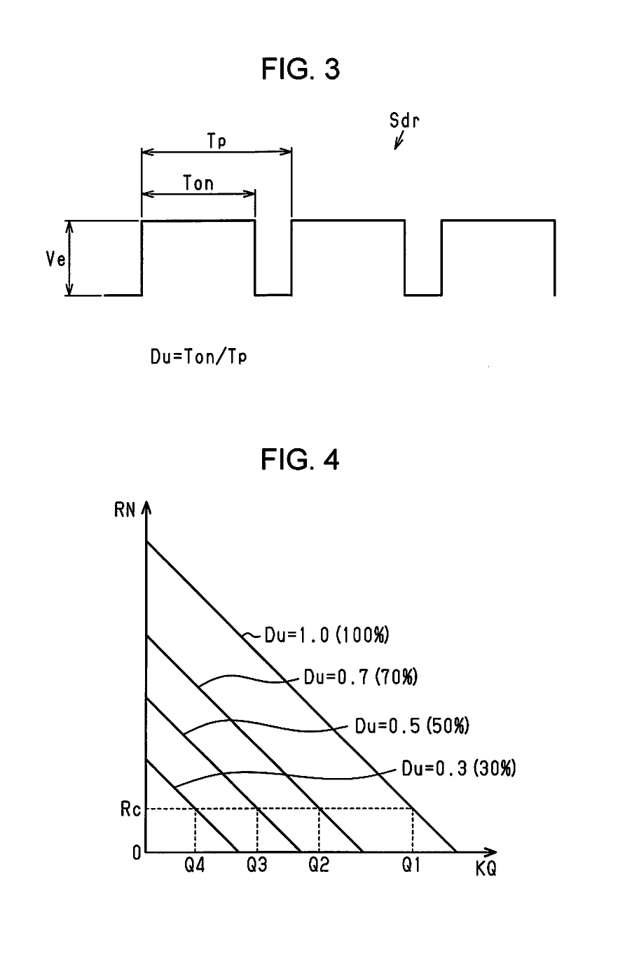

With reference to FIG. 3 and FIG. 4, the drive signal Sdr supplied to the CR motor 25 by the motor drive unit 51 and the rotational torque KQ of the CR motor 25 determined by the rotational torque determination unit 52 will be described.

As illustrated in FIG. 3, in the present embodiment, the drive signal Sdr supplied to the CR motor 25 is a voltage signal having a duty Du=Ton/Tp, which means that a voltage Ve is output during the period Ton of one cycle period Tp. A DC motor with a brush is used as the CR motor 25, and the drive current value of the CR motor 25 is proportional to the duty Du of the drive signal Sdr.

Further, as illustrated in FIG. 4, a torque/rotational speed characteristic line that indicates a relationship between the rotational torque KQ and the rotational speed RN exhibited by the CR motor 25 is defined for the duty Du of a corresponding drive signal Sdr. Note that FIG. 4 illustrates examples of respective torque/rotational speed characteristic lines for the drive signal Sdr corresponding to duty Du=1 (100%), the drive signal Sdr corresponding to duty Du=0.7 (70%), the drive signal Sdr corresponding to duty Du=0.5 (50%), and the drive signal Sdr corresponding to duty Du=0.3 (30%).

Therefore, according to the torque/rotational speed characteristic lines illustrated in FIG. 4, when the rotational speed RN of the CR motor 25 is a predetermined rotational speed, the rotational torque KQ of the CR motor 25 will correspond to the duty Du of the drive signal Sdr supplied to the CR motor 25.

For example, when the CR motor 25 is rotating at a rotational speed Rc in response to the drive signal Sdr corresponding to duty Du =0.5, the rotational torque KQ of the CR motor 25 will be torque Q3. Further, when the rotational speed RN of the CR motor 25 is the rotational speed Rc and the drive signal Sdr supplied from the CR motor drive circuit 66 has duty Du=0.7, which is greater than the duty Du=0.5, the rotational torque KQ will be torque Q2, which is greater than torque Q3. Furthermore, when the rotational speed RN of the CR motor 25 is the rotational speed Rc and the drive signal Sdr supplied from the CR motor drive circuit 66 has duty Du=1.0, which is greater than the duty Du=0.7, the rotational torque KQ will be torque Q1, which is greater than torque Q2. In contrast, when the rotational speed RN of the CR motor 25 is the rotational speed Rc and the drive signal Sdr supplied from the CR motor drive circuit 66 has duty Du=0.3, which is smaller than the duty Du=0.5, the rotational torque KQ will be torque Q4, which is smaller than torque Q3.

Therefore, in the present embodiment, the rotational speed RN of the CR motor 25 in accordance with the traveling speed of the carriage 22 is set as an input value in PID control, and the motor drive unit 51 supplies the drive signal Sdr having the duty Du which allows for the set rotational speed RN. That is, when a load due to the motion of the carriage 22 increases, the motor drive unit 51 increases the duty Du of the drive signal Sdr to be supplied to the CR motor 25 from the CR motor drive circuit 66 such that the CR motor 25 rotates at the set rotational speed RN. Since this causes the drive current value of the CR motor 25 to increase proportionally to the duty Du of the drive signal Sdr, the rotational torque KQ of the CR motor 25 increases. In such a way, the CR motor 25 is driven at the rotational torque KQ in accordance with the duty Du of the drive signal Sdr supplied from the CR motor drive circuit 66.

Further, the rotational torque determination unit 52 calculates the rotational speed RN of the CR motor 25 based on the traveling speed of the carriage 22 determined by the speed determination unit 53. The rotational torque determination unit 52 then determines, as the rotational torque KQ of the CR motor 25, a torque value corresponding to the calculated rotational speed RN of the CR motor 25 in accordance with the torque/rotational speed characteristic line of the CR motor 25 defined by the duty Du of the drive signal Sdr supplied from the CR motor drive circuit 66 to the CR motor 25.

In the present embodiment, the recording apparatus that drives the carriage 22, which is an example of a mobile unit, includes the CR motor 25, the belt 13 stretched between the first pulley 23 and the second pulley 24, the stopper 29, the motor drive unit 51, the rotational torque determination unit 52, and the speed determination unit 53.

Next, operation in the drive process of the carriage 22 performed by the recording apparatus configured as described above will be described with reference to the drawings.

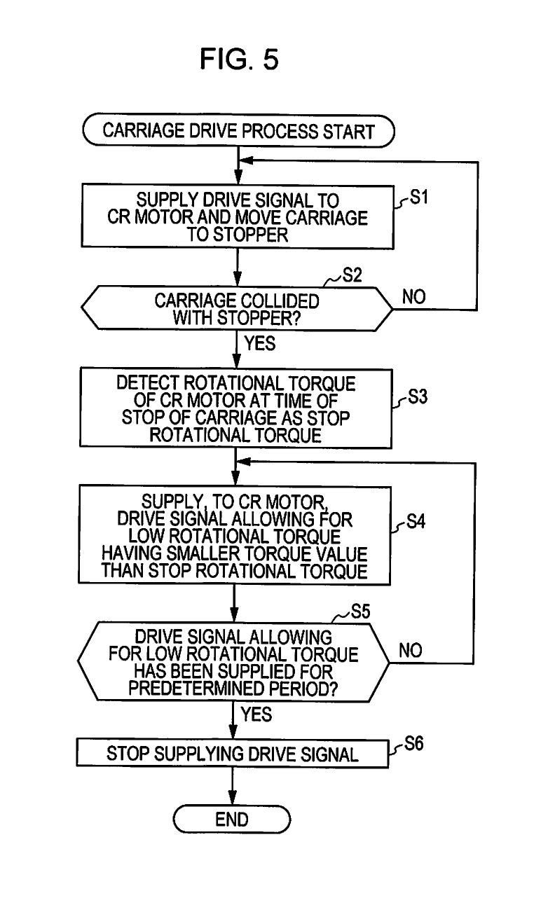

As illustrated in FIG. 5, upon the start of the carriage drive process, in step S1, a process of supplying the drive signal Sdr to the CR motor 25 to move the carriage 22 toward the stopper 29 is performed. In this step, the control unit 50 (the motor drive unit 51) supplies the drive signal Sdr of a predetermined duty Du (for example, Du=0.5) from the CR motor drive circuit 66 to the CR motor 25 so as to move the carriage 22 at a defined traveling speed. Therefore, the CR motor 25 rotates at a predetermined rotational speed RN (for example, the rotational speed Rc) corresponding to the defined traveling speed of the carriage 22, and the carriage 22 moves toward the stopper 29 in the reverse scan direction −X away from the first pulley 23.

Next, in step S2, a determination process as to whether or not the carriage 22 collides with the stopper 29 is performed. In this step, the control unit 50 determines whether or not the electrical signal input from the photo-sensor 31 to the main control circuit 65 is an electrical signal indicating that the motion of the carriage is inhibited by the stopper 29. For example, determination is made by identifying whether or not a signal waveform output from the photo-sensor 31 corresponding to the motion of the carriage 22 has changed from the previous signal waveform.

As a result of the process in step S2, if it is determined that the carriage 22 has not collided with the stopper 29 (step S2: NO), the process of step S1 is continued. If it is determined that the carriage 22 has collided with the stopper 29 (step S2: YES), a process of step S3 is entered.

Next, in step S3, a process of determining the rotational torque KQ of the CR motor 25 generated when the carriage 22 is stopped as a stop rational torque is performed. In this step, when the carriage 22 collides with the stopper 29 and stops the motion thereof, the control unit 50 (the rotational torque determination unit 52) determines, as the stop rotational torque, the rotational torque KQ defined in accordance with the duty Du of the drive signal Sdr being supplied to the CR motor 25.

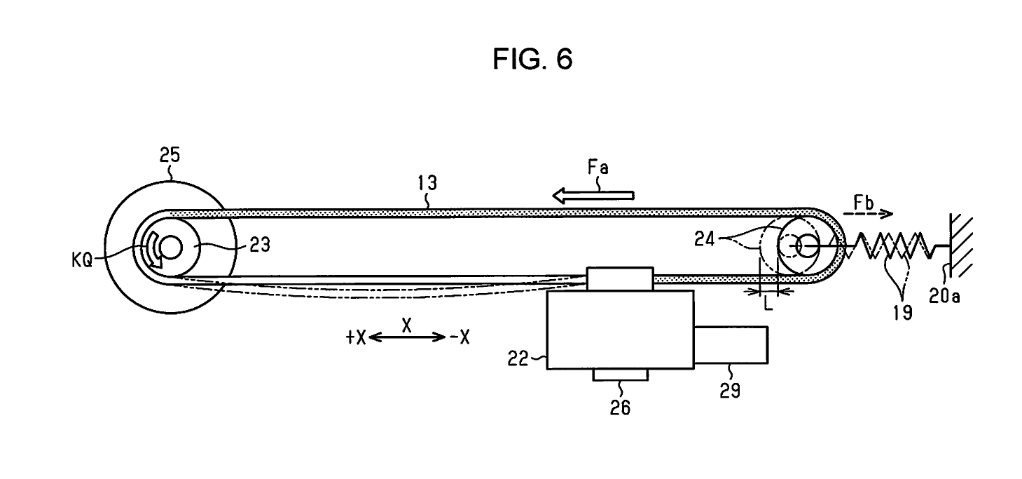

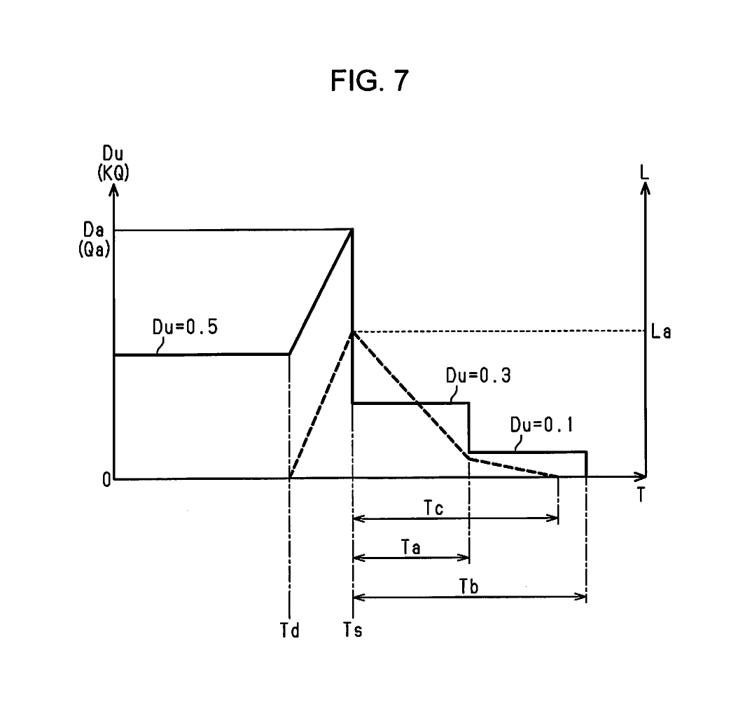

The processes of steps S1 to S3 will be further described with reference to FIG. 6 and FIG. 7.

As illustrated in FIG. 6, the carriage 22 moving in the reverse scan direction −X through the process of step S1 collides with the stopper 29. Since the motion in the reverse scan direction −X of the carriage 22 is restricted due to collision with the stopper 29, the downstream portion from the carriage 22 to the first pulley 23 in the rotating direction of the belt 13 is tensioned by force Fa caused by the rotation of the first pulley 23, as illustrated with a hatched portion in FIG. 6. Since the force Fa applying tension to the belt 13 causes the load against the rotation of the CR motor 25 to increase, the rotational speed RN of the CR motor 25 starts decreasing. Thus, the motor drive unit 51 supplies the drive signal Sdr having an increased duty Du and increases the rotational torque KQ of the CR motor 25 so as to maintain the rotational speed RN of the CR motor 25.

That is, as illustrated in FIG. 7, the drive signal Sdr corresponding to duty Du=0.5 causes the CR motor 25 to rotate at a predetermined rotational speed RN through the process of step S1, and the carriage 22 moving at the defined speed collides with the stopper 29 at the time Td on a time axis T after the start of the process, for example. In accordance with the load of the CR motor 25 which is increased by the stop of the motion of the carriage 22 due to the collision, the value of the duty Du of the drive signal Sdr becomes greater than 0.5 so as to increase the rotational torque KQ of the CR motor 25.

In the present embodiment, a threshold Da is set in advance as a value of the duty Du indicating that the carriage 22 has stopped at the reference position due to collision with the stopper 29. Then, when the value of the duty Du of the drive signal Sdr supplied to the CR motor 25 reaches the threshold Da at the time Ts when a predetermined time has elapsed from the time Td at which the carriage 22 collides with the stopper 29, it is determined that the carriage 22 is stopped at the reference position. Therefore, the control unit 50 (the rotational torque determination unit 52) determines, as a stop rotational torque Qa, the rotational torque of the CR motor 25 generated by the drive signal Sdr having the duty Du at which the threshold Da is reached.

For example, as illustrated in FIG. 4, at the time when the carriage 22 moving at a speed in accordance with the CR motor 25 rotating at the rotational speed Rc by the drive signal Sdr corresponding to duty Du=0.5 collides with the stopper 29, and when the threshold Da is set at a value 0.7, the control unit 50 (the rotational torque determination unit 52) determines the torque Q2 as the stop rotation torque Qa.

Note that the actual stop rotation torque Qa of the CR motor 25 will be greater than the torque Q2 as illustrated in the torque/rotational speed characteristic line, because the rotational speed RN of the CR motor 25 decreases due to the stop of the motion of the carriage 22. Further, although specific description is omitted here, when the increased rotational torque KQ of the CR motor 25 is reduced to be smaller by a predetermined value than the torque Q2 for accurate determination of the contact position of the carriage 22, the rotational torque of the reduced torque value is determined as the stop rotational torque Qa generated at the time when the carriage 22 stopped at the reference position.

As illustrated in FIG. 6 and FIG. 7, the force Fa generated by the increased rotational torque KQ tensions the belt 13 from the time Td to the time Ts that is from the time of collision of the carriage 22 and the stopper 29 to the time of stop of the carriage 22. This tension force causes the second pulley 24 to resist against pulling force Fb of the tension spring 19, resulting in a state where the second pulley 24 moved by a displacement L in the forward scan direction +X opposite to the pulling direction. That is, as illustrated in two-dot chain lines in FIG. 6, the downstream portion (the hatched portion in FIG. 6) from the carriage 22 to the first pulley 23 in the rotating direction of the belt 13 is pulled and moves by the force Fa, which causes the second pulley 24 to move toward the first pulley 23. Thus, as illustrated with a bold dashed line in FIG. 7, from the time Td to the time Ts, the tension spring 19 pulling the second pulley 24 in the reverse scan direction −X is expanded by elongation La corresponding to the displacement L of the second pulley 24 moving in the forward scan direction +X against the pulling force Fb.

In a state where the tension spring 19 is expanded by the elongation La as described above, if supply of the drive signal Sdr to the CR motor 25 were stopped as seen in the related art, the rotational torque KQ of the CR motor 25 would become zero and therefore the force Fa tensioning the belt 13 would no longer be generated. As a result, the tension spring 19 that has been pulled by the elongation La would rapidly recover the original length thereof due to the pulling force Fb. At this time, the tension spring 19 recovering the original length thereof would cause the second pulley 24 (the slide plate 18) to rapidly move in the reverse scan direction −X, and such a rapid motion of the second pulley 24 would cause a noise to suddenly occur in the recording apparatus.

Referring back to FIG. 5, in the next step S4, a process of supplying, to the CR motor 25, the drive signal Sdr allowing for a low rotational torque having a smaller torque value than the stop rotational torque Qa is performed. In this step, after determining the stop rotational torque Qa, the control unit 50 supplies, to the CR motor 25, the drive signal Sdr by which the rotational torque KQ of the CR motor 25 becomes a plurality of (two, in this example) low rotational torques having different values that are smaller than the stop rotation torque Qa.

That is, in the present embodiment, within a predetermined period Tb from the time Ts, which is the time of determination of the stop rotational torque Qa, to the time Tb, the control unit 50 sequentially supplies, to the CR motor 25, the drive signal Sdr which allows for a low rotational torque of the larger torque value of the two torque values and then the drive signal Sdr which allows for a low rotational torque of the smaller torque value of the two torque values. For example, as illustrated in FIG. 7, the drive signal Sdr corresponding to duty Du=0.3 allowing for a low rotational torque of the larger torque value during a period Ta that is shorter than the predetermined period Tb after the time Ts of determination of the stop rotational torque Qa, and the drive signal Sdr corresponding to duty Du=0.1 is then supplied until the end of the period Tb after the period Ta has elapsed.

As a result, after the determination of the stop rotational torque Qa, the rotational torque KQ of the CR motor 25 becomes respective torque values corresponding to the supplied drive signal Sdr corresponding to duty Du=0.3 and the supplied drive signal Sdr corresponding to duty Du 0.1, and the force Fa tensioning the belt 13 is generated in accordance with these torque values. The generated force Fa is applied to the second pulley 24 in a direction opposite to the pulling direction (the reverse scan direction −X) in which the tension spring 19 pulls the second pulley 24, as illustrated in FIG. 6, which suppresses rapid motion of the second pulley 24 in the reverse scan direction −X.

Further, as illustrated in FIG. 7, in a state where the tension spring 19 is expanded by the elongation La in the forward scan direction +X, the pulling force Fb in the reverse scan direction −X of the tension spring 19 has increased in accordance with the elongation La. Thus, the drive signal Sdr corresponding to duty Du=0.3 allowing for a low rotational torque of the larger torque value is first supplied so as to resist the increased pulling force Fb. Then, at the end of the period Ta at which the expanded tension spring 19 is contracted by the pulling force Fb and the elongation La becomes a predetermined length, the drive signal Sdr corresponding to duty Du=0.1 allowing for a low rotational torque of the smaller torque value is supplied.

As a result, as illustrated with a bold dashed line in FIG. 7, for example, the tension spring 19 is gradually contracted from the expanded state by the elongation La, and gradually moves at a constant speed or a stepwise decreasing speed to a position where the elongation La becomes zero at the time when the period Tc has elapsed, that is, at the previous position where the second pulley 24 was before the motion in the direction opposite to the pulling direction of the tension spring 19.

Further, in the present embodiment, the duties Du of the drive signal Sdr supplied after the time Ts to the CR motor 25 is a duty Du=0.3 and a duty Du=0.1 that are smaller than a duty Du=0.5 of the drive signal Sdr supplied for moving the carriage 22 until the time Td at which the carriage 22 collides with the stopper 29. That is, in the motion unit drive apparatus, the low rotational torque of the CR motor 25 is set to a torque value smaller than the rotational torque KQ of the CR motor 25 generated when the carriage 22 moves in response to rotation of the belt 13. Therefore, the torque value of the low rotational torque is set to a torque value which does not generate the force Fa tensioning the belt 13 against the spring force (the pulling force Fb) occurring when the tension spring 19 is expanded even slightly (for example, even by 1 mm), that is, set to a torque value which does not move the second pulley 24 in the direction opposite to the pulling direction of the tension spring 19.

Turning back to FIG. 5, in the next step S5, a process of determining whether or not the drive signal Sdr allowing for a low rotational torque has been supplied for a predetermined period Tb is performed. In this step, the control unit 50 measures the elapsed time from the time Ts and determines whether or not the set predetermined period Tb has elapsed. As a result of the determination, if the predetermined period Tb has not elapsed (step S5: NO), the process returns to step S4 and continues the process of supplying the drive signal Sdr allowing for a low rotational torque to the CR motor 25.

On the other hand, as a result of the determination, if the predetermined period Tb has elapsed (step S5: YES), a process of stopping supply of the drive signal Sdr is performed in step S6, and the process then ends. In the process of step S6, the motor drive unit 51 stops the output of the drive signal Sdr from the CR motor drive circuit 66 and stops supplying the drive signal Sdr to the CR motor 25.

In the present embodiment, as illustrated in FIG. 7, the predetermined period Tb is longer than the period Tc which is until the second pulley 24 that is moved in the direction (the forward scan direction +X) opposite to the pulling direction by the tension spring 19 at the time of stop of the carriage 22 returns to the previous position that corresponds to a position before the motion in the direction opposite to the pulling direction. In other words, in this process of carriage motion, the predetermined period Tb is set longer than the period Tc.

Note that, in the drive process of the carriage 22 illustrated in FIG. 5, step S1 and step S2 correspond to a motion unit collision step of moving the carriage 22 from the first pulley 23 side to the second pulley 24 side in the rotating direction of the belt 13 and causing the carriage 22 to collide with the stopper 29. Further, step S3 corresponds to a rotational torque determination step of determining the stop rotational torque Qa of the CR motor 25 indicating stop of the carriage 22 due to the collision with the stopper 29. Furthermore, step S4, step S5, and step S6 correspond to a drive signal supply step of supplying, from the motor crive unit 51 to the CR motor 25, the drive signal Sdr allowing the rotational torque KQ of the CR motor 25 to be a low rotational torque that is smaller than the stop rotational torque Qa within the predetermined period Tb from the determination of the stop rotational torque Qa in the rotational torque determination step.

According to the embodiment described above, the following advantages can be obtained.

(1) At the time of stop of the carriage 22, the drive signal Sdr supplied to the CR motor 25 is not a signal which causes the rotational torque KQ to be zero. Therefore, the belt 13 is tensioned in the rotating direction in response to the rotation of the first pulley 23 rotated by the CR motor 25 having the stop rotational torque Qa, which can suppress the second pulley 24 that moves in the direction opposite to the pulling direction of the tension spring 19 from quickly returning to the previous position that corresponds to a position before the motion. This can suppress occurrence of a noise (a sudden noise) when the carriage 22 stops.

(2) Due to a low rotational torque which causes no motion of the second pulley 24 in the direction opposite to the pulling direction applied by the tension spring 19, the second pulley 24 that moves when the carriage 22 stopped, can be stably returned to the previous position that corresponds to a position before the motion with the belt 13 being tensioned, for example.

(3) The predetermined period Tb of the low rotational torque is longer than the period Tc during which the second pulley 24 returns to the previous position that corresponds to a position before the motion, and this can suppress at a high probability the second pulley 24 that moves when the carriage 22 stopped, from quickly moving before returning to the previous position.

(4) The motor drive unit 51 supplies no drive signal Sdr to the CR motor 25 after the predetermined period Tb, that is, after the second pulley 24 that is moved when the carriage 22 stopped returns to the previous position, and this can suppress generation of heat of the CR motor 25.

(5) Since the rotational torque KQ of the CR motor 25 after the carriage 22 stopped is the rotational torque KQ corresponding to the pulling force Fb of the tension spring 19 changing with the elongation La, the second pulley 24 that moves when the carriage 22 stopped can be gradually returned to the previous position that corresponds to a position before the motion, for example, at a constant speed, a speed decreasing stepwise, or the like.

Note that the embodiment describe above may be modified as below.

In the embodiment described above, the speed determination unit 53 determines the traveling speed of the carriage 22 moving to the stopper 29. The motor drive unit 51 may then supply, to the CR motor 25, the drive signal Sdr which allows for the rotational torque KQ corresponding to the traveling speed of the carriage 22 at the time of collision with the stopper 29 determined by the speed determination unit 53 as the drive signal Sdr which allows for a low rotational torque.

As illustrated in FIG. 4, the rotational torque KQ of the CR motor 25 when the carriage collides with the stopper 29 changes in accordance with the rotational speed RN of the CR motor 25 on the torque/rotational speed characteristic line identified by the duty Du of the drive signal Sdr being supplied to the CR motor 25 at this time. Therefore, in this modified example, from the torque/rotational speed characteristic line, the speed determination unit 53 that determines the traveling speed of the carriage 22 moving toward the stopper 29 calculates the rotational torque KQ of the CR motor 25 corresponding to the rotational speed RN of the CR motor 25 calculated based on the determined traveling speed of the carriage 22, for example. The motor drive unit 51 may then supply, to the CR motor 25, the drive signal Sdr which results in a torque value (for example, a torque value smaller than that of the rotational torque KQ) corresponding to the calculated rotational torque KQ of the CR motor 25, as the drive signal Sdr which results in the low rotational torque.

According to this modified example, the following advantages can be obtained in addition to the advantages (1) to (5) of the embodiment described above.

(6) When the second pulley 24 moves by the displacement L corresponding to the rotational torque KQ of the CR motor 25 that can be calculated from the traveling speed at collision of the carriage 22, rapid motion of the second pulley 24 to the previous position can be properly suppressed by a low rotational torque having a torque value corresponding to the displacement L of the second pulley 24. Therefore, for example, resisting against the pulling force Fb of the tension sprint 19 that increases with the displacement L of the second pulley 24, the second pulley 24 is able to slowly return to the previous position that corresponds to a position before the motion.

In the embodiment described above, the low rotational torque of the CR motor 25 may have more than two different torque values. In this case, it is preferable for the motor drive unit 51 to sequentially supply to the CR motor 25 the drive signal Sdr in descending order of rotational torque among the plurality of torque values of the low rotational torques within the predetermined period Tb.

In the embodiment described above, the low rotational torque of the CR motor 25 may have a single torque value instead of a plurality of torque values. In this case, the motor drive unit 51 may supply either one of the drive signal Sdr corresponding to duty Du=0.3 and the drive signal Sdr corresponding to duty Du=0.1 illustrated in FIG. 7, for example, to the CR motor 25 as the drive signal Sdr of the low rotational torque having the single torque value within the predetermined period Tb.

In the embodiment described above, the motor drive unit 51 may not necessarily stop supplying the drive signal Sdr to the CR motor 25 after the predetermined period Tb. For example, after supplying the drive signal Sdr of a low rotational torque, the drive signal Sdr which allows for the rotational torque KQ having a torque value small enough not to cause the carriage 22 to move from the second pulley 24 side to the first pulley 23 side may be supplied to the CR motor 25 so that the carriage 22 remains at the collision position (the reference position).

In the embodiment described above, the predetermined period Tb may not necessarily be longer than the period Tc during which the second pulley 24 that is moved in the direction opposite to the pulling direction of the tension spring 19 at the time of stop of the carriage 22 returns to the previous position that corresponds to a position before the motion. For example, the predetermined period Tb may be the same length as the period Tc, or the predetermined period Tb may be shorter than the period Tc. Note that, when the predetermined period Tb is shorter than the period Tc, it is preferable that the predetermined period Tb be a period during which the second pulley 24 that is moved by the displacement L in the direction opposite to the pulling direction moves up to a position close to the previous position that corresponds to a position before the motion such as a position where the second pulley 24 returns the half distance or more of the displacement L, for example.

In the embodiment described above, the low rotational torque may have a larger torque value than the rotational torque KQ of the CR motor 25 when the carriage 22 moves in response to rotation of the belt 13. For example, in FIG. 7, the drive signal Sdr of at least a duty Du=0.3 supplied to the CR motor 25 within the predetermined period Tb may be the drive signal Sdr having a larger duty than a duty Du=0.5 of the drive signal Sdr supplied when the carriage 22 is moved to the stopper 29. Originally, the rotational torque KQ of the CR motor 25 due to the drive signal Sdr having such a larger duty Du has a smaller torque value than the stop rotational torque Qa, and it is therefore preferable that the force Fa tensioning the belt 13 generated via the first pulley 23 be smaller than the pulling force Fb of the tension spring 19.

In the embodiment described above, the recording apparatus may have more than two pulleys. In this case, of the plurality of pulleys, one or more pulleys rotated by the CR motor 25 can be defined to be the first pulley 23, and one or more pulleys pulled by the tension spring and be movable in the pulling direction can be defined to be the second pulley 24.

In the embodiment described above, as the actuation member, a compression spring may be employed instead of the tension spring 19. In this case, the compression spring may be arranged compressed in the opposite side of the tension spring 19 with respect to the second pulley 24 so as to push the slide plate 18 from the forward scan direction +X side to the reverse scan direction −X side.

In the embodiment described above, the stopper 29 may function as a. paper feed selection unit that switches feeding of the sheet P between the first paper feed tray 41 and the second paper feed tray 45. This modified example will be described with reference to the drawing.

As illustrated in FIG. 8, in the printer 11, an interlocking gear 42c that interlocks with and rotates a transmission gear 42b of the paper feed mechanism 42 provided to the first paper feed tray 41 and an interlocking gear 46c that interlocks with and rotates a transmission gear 46b of the paper feed mechanism 46 provided to the second paper feed tray 45 are arranged in the scan direction X and supported in a rotatable manner, respectively. Further, in the printer 11, a drive gear 14G that is able to engage with the interlocking gear 42c as well as the interlocking gear 46c and is driven and rotated by a drive motor (not shown) is supported in a rotatable manner, and a slide unit 14 that is slidable in the scan direction X is attached thereto.

The slide unit 14 has, in the scan direction X, a lever portion 14a located in the −X side in the reverse scan direction and a lever portion 14b located in the +X side in the forward scan direction. The carriage 22 moving in the reverse scan direction -x in the scan direction X is able to come into contact with the lever portion 14a, and the carriage 22 moving in the forward scan direction +X in the scan direction X is able to come into contact with the lever portion 14b.

The slide unit 14 is now in a state that the drive gear 14G engages with the interlocking gear 42c as illustrated with solid lines in FIG. 8. In this state, since rotation of the drive gear 14G causes rotation of the interlocking gear 42c, the transmission gear 42b of the paper feed mechanism 42 rotates in response to the interlocking gear 42c. As a result, the paper feeder roller 42a rotates in the paper feed mechanism 42, and thereby the sheet P is fed from the first paper feed tray 41.

From this state, the carriage 22 is moved in the reverse scan direction −X to cause the carriage 22 to come into contact with the lever portion 14a. Then, together with further motion of the carriage 22 in the reverse scan direction −X, the slide unit 14 having the lever portion 14a contact with the carriage 22 slides and moves in the reverse scan direction -x until collides with the stopper 29 with the lever portion 14a being pressed against the stopper 29, as illustrated in a two-dot chain line in FIG. 8. In response to the slide motion of the slide unit 14 in the reverse scan direction −X, the drive gear 14G is released from the engagement with the interlocking gear 42c and then engages with the interlocking gear 46c. In this state, since rotation of the drive gear 14G causes rotation of the interlocking gear 46c, the transmission gear 46b of the paper feed mechanism 46 interlocks with the interlocking gear 46c and rotates accordingly. As a result, the paper feed roller 46a of the paper feed mechanism 46 rotates, and the sheet P is fed from the second paper feed tray 45.

In such a way, the carriage 22 moving in the reverse scan direction −X collides with the stopper 29 with the lever portion 14a of the slide unit 14 pressed against the stopper 29, and thereby the stopper 29 restricts and positions the slide motion of the slide unit 14 in the reverse scan direction −X by the collision. This positioning of the slide unit 14 by using the stopper 29 causes the feeding source of the sheet P to be switched from the first paper feed tray 41 to the second paper feed tray 45. That is, the stopper 29 has a function of a paper feed selection unit that selects one of the first paper tray 41 and the second feed tray 45 to supply the sheet P, in addition to the function of positioning of the carriage 22 to the reference position.

Note that the stopper 29 may be configured such that the carriage moving in the forward scan direction +X collides with the stopper 29 with the lever portion 14b of the slide unit 14 being pressed against the stopper 29. This collision of the carriage 22 causes the slide unit 14 to slide and move in the forward scan direction +X with the motion of the carriage 22, and the lever portion 14b then collides with the stopper (not depicted in FIG. 8). In response to the slide motion of the slide unit 14 in the forward scan direction +X, the drive gear 14G is released from the engagement with the interlocking gear 46c and then engages with the interlocking gear 42c, as illustrated with solid lines in FIG. 8.

In the embodiment described above, the ejecting head 26 may eject less than four colors of ink or may eject more than four colors of ink as multiple colors of ink.

In the embodiment described above, the ink may be supplied from an ink tank (not depicted) provided outside the apparatus main unit 12, for example, instead of the ink cartridge 27.

For example, the printer 11 of the embodiment described above may be a large format printer that performs printing (recording) on the sheet P that is an example of a length of printing medium. In this case, the printer 11 may be configured such that the sheet P is unwound from a rolled state and transported on the support stage 28.

In the embodiment described above, a liquid used for printing may be a fluid other than ink (a liquid, a liquid-like material in which particles of a functional material are dispersed or mixed, a fluid-like material such as a gel, a liquid containing a solid that can be ejected as a flow). For example, recording may be performed by ejecting a liquid containing a dispersed or dissolved material such as an electrode material or a color material (a pixel material) used for manufacturing a liquid crystal display, an electroluminescence (EL) display, and a flat panel display.

In the embodiment described above, the printer 11 as a printing apparatus may be a fluid-like material ejecting apparatus that ejects a fluid-like material such as a gel (for example, a physical gel). Note that, in the present specification, “fluid” refers to a concept not including a fluid consisting only of a gas, and a fluid may be a liquid (including an inorganic solvent, an organic solvent, a solvent, a liquid resin, a liquid metal (a metallic melt), and the like), a liquid-like material, a fluid-like material, or the like, for example.

The entire disclosure of Japanese Patent Application No. 2016-107275, filed May 30, 2016 is expressly incorporated by reference herein.

What is claimed is:

1. A recording apparatus comprising:
a drive motor that rotates in response to a supplied drive signal;
a motor drive unit that supplies a drive signal to the drive motor;
a belt that is stretched between a first pulley that is rotated by the drive motor and a second pulley that is movable in an actuation direction by being actuated by an actuation member and that is rotatable in response to rotation of the first pulley;
a motion unit that is attached to the stretched belt and moves in response to rotation of the belt;
a stopper that stops the motion unit from traveling from the first pulley side to the second pulley side in a rotating direction of the belt by causing the motion unit to collide with the stopper; and
a rotational torque determination unit that determines a stop rotational torque of the drive motor after the motion unit collides with the stopper,
wherein, within a predetermined period from determination of the stop rotational torque by the rotational torque determination unit, the motor drive unit supplies to the drive motor the drive signal that causes a rotational torque of the drive motor to be less than the stop rotational torque.

2. The recording apparatus according to claim 1, wherein the low rotational torque is smaller than a rotational torque of the drive motor generated when the motion unit moves in response to rotation of the belt.

3. The recording apparatus according to claim 1, wherein the predetermined period is longer than a period that elapses before the second pulley that is moved in a direction opposite to the actuation direction by the actuation member moves to a previous position that corresponding to a position before moving in the direction opposite to the actuation direction after the motion unit stopped.

4. The recording apparatus according to claim 1, wherein the motor drive unit stops supplying the drive signal to the drive motor after the predetermined period.

5. The recording apparatus according to claim 1 further comprising a speed determination unit that determines a traveling speed of the motion unit moving to the stopper,
wherein the motor drive unit supplies, to the drive motor as the drive signal causing the low rotational torque, the drive signal that corresponds to a rotational torque corresponding to a traveling speed of the motion unit determined by the speed determination unit when the motion unit collides with the stopper.

6. The recording apparatus according to claim 1,
wherein the low rotational torque has a plurality of different torque values, and
wherein the motor drive unit sequentially supplies to the drive motor the drive signals in descending order of rotational torque among the plurality of torque values of the low rotational torque values within the predetermined period.

7. A motion unit drive method of moving a motion unit by supplying a drive signal from a motor drive unit to rotate a drive motor, the motion unit being attached to a belt that is stretched between a first pulley that is rotated by the drive motor and a second pulley that is movable in an actuation direction by being actuated by an actuation member and that is rotatable in response to rotation of the first pulley, the method comprising:
a collision step of moving the motion unit from the first pulley side to the second pulley side in a rotating direction of the belt and causing the motion unit to collide with a stopper;
a rotation torque determination step of determining a stop rotational torque of the drive motor after causing the motion unit to collide with the stopper; and
a drive signal supplying step of, within a predetermined period from determination of the stop rotational torque in the rotational torque determination step, supplying to the drive motor the drive signal that causes a rotational torque of the drive motor to be a low rotational torque having a smaller torque value than the stop rotational torque.
